(19) United States
(12) Patent Application Publication
(10) Pub. No.: US 2025/0044400 A1
(43) Pub. Date: Feb. 6, 2025

(54) Hand-Held Unit for Controlling a Motor Vehicle

(71) Applicant: Bayerische Motoren Werke Aktiengesellschaft, Muenchen (DE)

(72) Inventors: Kai HOESL, Iffeldorf (DE); Helmut WAGATHA, Oberschleissheim (DE)

(21) Appl. No.: 18/742,846

(22) Filed: Jun. 13, 2024

(30) Foreign Application Priority Data
Aug. 3, 2023 (DE) 10 2023 120 589.7

(51) Int. Cl. G01S 5/14; G05D 1/226

(52) U.S. Cl. CPC G01S 5/14; G05D 1/226

(57) ABSTRACT

A method for locating a hand-held unit with respect to a motor vehicle includes negotiating a time interval between the hand-held unit and the motor vehicle on the strength of a capability of an energy source of the hand-held unit. A series of wireless impulses between the motor vehicle and the hand-held unit are transmitted, where the wireless impulses are transmitted in a manner offset by a time interval. A location of the hand-held unit in relation to the motor vehicle is determined on the basis of intervals of time between reception times of the wireless impulses at the hand-held unit.

### CROSS REFERENCE TO RELATED APPLICATION

This application claims priority under 35 U.S.C. § 119 from German Patent Application No. DE 10 2023 120 589.7, filed Aug. 3, 2023, the entire disclosure of which is herein expressly incorporated by reference.

### BACKGROUND AND SUMMARY

The present invention relates to control of a motor vehicle. In particular, the invention relates to control of the motor vehicle by means of a hand-held unit.

A motor vehicle comprises a control apparatus designed to control a safety function of the motor vehicle, for example opening or closing the motor vehicle or activating or deactivating an engine immobilizer. Control can be accomplished using a wirelessly communicating hand-held unit, which may be integrated in a mechanical key or may be in the style of a key fob, for example. Operation of the hand-held unit can result in messages being exchanged between the hand-held unit and the motor vehicle in order to perform the safety function. A hand-held unit dedicatedly designed for communication with the motor vehicle normally uses LF (125 kHz) or HF (434 MHz) radio technology.

Wireless control of the safety function of the motor vehicle can also be accomplished using a mobile device (smartphone). Radio technologies used in this context include Bluetooth Low Energy (BLE) at a frequency of approximately 2.4 GHz and ultra-wideband (UWB) in a frequency range from approximately 6 to approximately 10 GHz. Preferably, the two aforementioned radio technologies are used in an intertwined manner so as firstly to handle secure communication and secondly to determine a position of the mobile device in relation to the motor vehicle. Much more comprehensive safety concepts are possible than with a dedicated hand-held unit. By way of example, control can be performed according to a standard known as Digital Car Key, which is disclosed by the Car Connectivity Consortium.

To be able to use the motor vehicle even without a cell phone, a hand-held unit is supposed to be equipped with the technology of a mobile device. To be able to produce the hand-held unit in a small and lightweight form, an energy source of the hand-held unit has the smallest possible dimensions. A known method of locating the hand-held unit in relation to the motor vehicle by means of UWB can result in a heavy load on the energy source arising during reception of a series of wireless impulses. By way of example, the energy source may comprise a button cell that should be loaded only by a small current of approximately 10 to 15 mA, a much larger current of, for example, approximately 130 mA briefly being able to be drawn during reception.

An impulse-like energy draw can be smoothed by using a capacitor. If the button cell is in a good state, reception of the sequence of wireless impulses may be unproblematic. If the button cell is operating under less than optimum conditions, however, for example because it is already partially discharged or low temperatures are prevailing, the voltage provided for the hand-held unit can briefly fall below a predetermined threshold value during reception, meaning that processing may be disrupted.

An object on which the present invention is based is to provide an improved technique for communication between a hand-held unit and a motor vehicle. The invention achieves this object by means of the subjects of the independent claims.

According to a first aspect of the present invention, a method for locating a hand-held unit with respect to a motor vehicle comprises steps of negotiating a time interval between the hand-held unit and the motor vehicle; transmitting a series of wireless impulses from the motor vehicle to the hand-held unit; the wireless impulses being transmitted from different positions on the motor vehicle in a manner offset by the time interval; and determining a location of the hand-held unit in relation to the motor vehicle on the basis of intervals of time between reception times of the wireless impulses at the hand-held unit. The time interval is negotiated on the strength of a capability of an energy source of the hand-held unit.

It is thus possible to prevent the energy source from being loaded to such a great extent during reception of the wireless impulses that the functioning of another component of the hand-held unit is impaired. Functional safety of the hand-held unit may thereby be improved. The hand-held unit can be operated with improved safety even under adverse conditions.

Preferably, the time interval is extended as the capability of the energy source falls. If the capability of the energy source is high, the time interval can be chosen to be short and, for example, may be approximately 1.333 ms. If the capability of the energy source is only moderate, the time interval can be raised to an average length of, for example, approximately 2.667 ms. If the capability of the energy source is at the lower end of a usable range, the time interval can be raised to a long time of, for example, 4.00 ms. Normally, as many impulses are transmitted in the series during location as there are transmitting devices at different positions on the motor vehicle. The number of transmitting devices is normally a single digit, meaning that even with a long time interval no noticeable delay can be detected by a person operating the hand-held unit compared with a short time interval.

In at least one embodiment, the energy source provides a voltage, the capability being determined on the strength of the provided voltage. To put it another way, a voltage of the energy source can be used as an indicator of a state of charge (SoC). The voltage is preferably determined as an open-circuit voltage if the energy source is not significantly loaded by a load. In particular if the energy source comprises an electrochemical energy store and is a storage battery or battery, the voltage can indicate the state of charge to a good approximation. The higher the state of charge, the greater may be the capability of the energy source.

In at least one embodiment, in which the energy source provides a voltage, the capability can be determined on the strength of an electrical internal resistance of the energy source. The lower the electrical internal resistance, the greater may be the capability. The internal resistance can be determined by connecting an electrical load to the energy source and determining a current flowing through the load on the strength of a voltage across it. The load may comprise in particular a transmitter or a receiver of the hand-held unit.

If the energy source comprises an electrochemical energy store, the capability can be determined on the strength of a temperature in the region of the energy store. The lower the temperature, the lower may be the capability. Factors that can be taken into consideration in this instance are that a battery and a storage battery can have their capability impaired if they are used in cold temperatures. The temperature in the region of the energy source can easily be determined, for example by means of a temperature-dependent device, for example a diode.

If the energy source comprises an energy store, the capability of the energy store can be determined on the basis of past energy draws from the energy store. The energy store is non-regenerative, and so only a predetermined amount of energy can be drawn therefrom. A model can be formed for energy that can still be drawn from the energy store. The more often energy has been drawn from the energy store or the larger an energy draw has been, the smaller may be an energy remaining in the energy store. To put it another way, the capability of the energy store can fall the more energy has already been drawn therefrom. Good models of this kind are known in particular for storage batteries and batteries.

A hand-held unit for communication with a motor vehicle comprises a wireless transceiver; an energy source; and a processing device. The processing device is designed to negotiate a time interval with a motor vehicle; to receive a series of wireless impulses transmitted from different positions on the motor vehicle in a manner offset by the time interval; and to determine a location of the hand-held unit in relation to the motor vehicle on the basis of intervals of time between reception times of the wireless impulses at the hand-held unit. The processing device is designed to negotiate the time interval on the strength of a capability of the energy source of the hand-held unit.

The technique presented herein can be applied both for the transmission of impulses from the motor vehicle to the hand-held unit and in the opposite direction. A transceiver comprises a transmitter and a receiver. If only the direction from the hand-held unit to the motor vehicle is supposed to be covered, there may be provision for only a transmitter instead of the transceiver. If only transmission from the motor vehicle to the hand-held unit is supposed to be provided with the presented technique, it is accordingly possible to use only a receiver instead of the transceiver. The focus herein is a transceiver in a general way; a possible reduction to a transmitter or a receiver is implied thereby.

The processing device is preferably also designed to determine a present capability of the energy source. A method described herein can be performed in part or in full by means of the hand-held unit and in particular by means of the processing device. To this end, the processing device may be electronic and may comprise, for example, an integrated circuit, a programmable logic chip or a programmable microcomputer. The method may be implemented in the form of a configuration or as a computer program product containing program code means for the processing device. The configuration or the computer program product may be stored on a computer-readable data carrier. Features or advantages of the method can be transferred to the apparatus, or vice versa.

In at least one embodiment, the transceiver is activated only if the arrival of a wireless impulse is expected or an impulse is supposed to be transmitted. A voltage of the energy source may be reduced while the transceiver is activated. To prevent the voltage from falling to such an extent during transmission or reception of the wireless impulses that the functioning of the processing device is impaired, the time interval can be extended. An energy drawn from the energy source during transmission or reception of the series of impulses can remain the same as a result of the extension of the time interval, but the load can be distributed over a longer period. A brief dip in the voltage of the energy source can thereby be prevented.

Preferably, the energy source comprises a buffer store in order to briefly provide an increased electric current. The buffer store may be in particular a capacitor. The capacitor can likewise contribute to reducing a brief load on the energy source. The energy source can thus be loaded with improved uniformity.

In at least one embodiment, the processing device is designed to extend the time interval if a voltage of the energy source drops below a predetermined threshold value during activation of the wireless transceiver. To put it another way, it is possible to determine whether the voltage of the energy source falls inadmissibly during transmission or reception of the series of impulses. If this is the case, the time interval can be extended in order to prevent the voltage from falling sharply again. The time interval can be set to a short value again if the energy source is charged or replaced.

The hand-held unit may comprise a reset generator in order to put the processing device into a predetermined state if the voltage drops below the predetermined threshold value. The reset generator together with the processing device may be, for example, an integrated circuit or a microcontroller. The use of a reset generator on a digital processing device is customary. The reset generator can be used to detect a state of the undervoltage that is harmful or disruptive to operation of the processing device.

More preferably, the hand-held unit comprises a further wireless interface for communication with the motor vehicle. The described wireless transceiver may be part of a first wireless interface that operates in particular using UWB technology. The further wireless interface may operate, for example, according to the Bluetooth standard, in particular Bluetooth Low Energy (BLE). Both interfaces can be operated according to a predetermined protocol in order to handle communication between the hand-held unit and the motor vehicle. Preferably, the hand-held unit implements a protocol that is already known. The protocol may be included in particular by Digital Car Key.

A communication standard implemented by the hand-held unit may provide for a maximum or minimum time interval for communication between the hand-held unit and the motor vehicle. In one embodiment, such a restriction can be exceeded or underrun in order to realize a technique as described herein and to prevent location of the hand-held unit with respect to the motor vehicle from failing if the energy source of the hand-held unit has insufficient capability.

It is particularly preferred for the hand-held unit to be designed to take information exchanged with the motor vehicle as a basis for controlling a function of the motor vehicle. In particular, the hand-held unit can carry out a bilateral authentication with the motor vehicle and request a predetermined function of the motor vehicle. The function may include, for example, unlocking, opening or enabling a driving function of the motor vehicle. The hand-held unit is preferably a dedicated device that can be used for no other purpose than communication with the motor vehicle. Nevertheless, in terms of controlling the function of the motor vehicle, the hand-held unit can operate in a similar manner to a mobile device (smartphone), which can additionally perform other functions as well.

Other objects, advantages and novel features will become apparent from the following detailed description of one or more preferred embodiments when considered in conjunction with the accompanying drawings.

### BRIEF DESCRIPTION OF THE DRAWINGS

FIG. 1 illustrates a system;

FIG. 2 illustrates exemplary voltage characteristics on a hand-held unit; and

FIG. 3 illustrates a flowchart for a method.

### DETAILED DESCRIPTION OF THE DRAWINGS

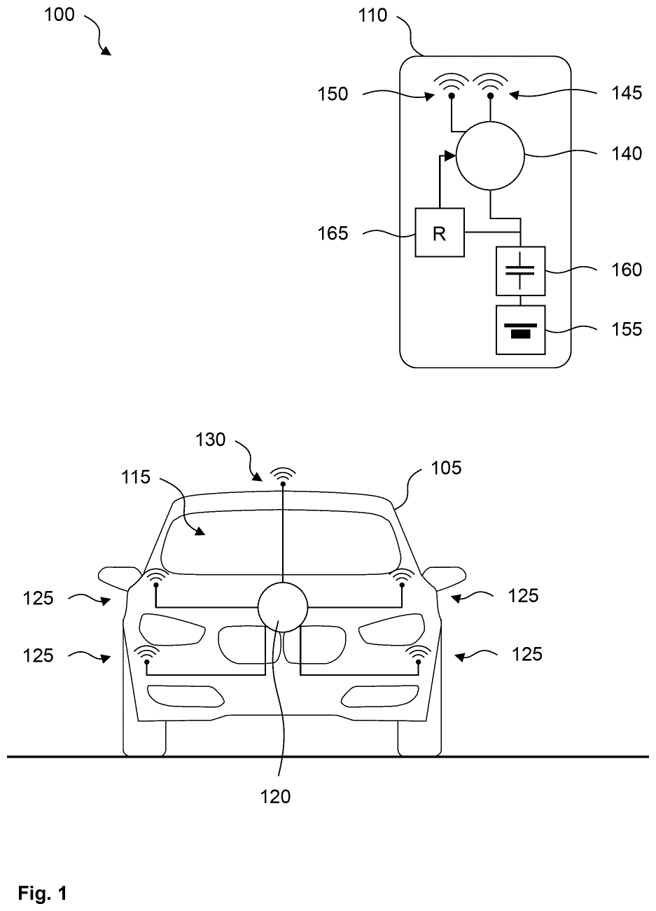

FIG. 1 shows a system 100 that comprises a motor vehicle 105 and a hand-held unit 110. Aboard the motor vehicle 105 there is provision for a control apparatus 115, which is designed to communicate with the hand-held unit 110 and to control a function of the motor vehicle 105. The function may include in particular a safety function such as locking or unlocking an access lock. The control apparatus 115 comprises a processing device 120, multiple wireless interfaces 125 and a further wireless interface 130. An interface 125 normally comprises a transceiver as a combination of a transmitter with a receiver. The transmitter and the receiver may also be constructed separately from one another. Strictly speaking, a communication by the motor vehicle 105 is always effected by means of the control apparatus 115; to simplify matters, the text below also refers to the hand-held unit 110 communicating with the motor vehicle 105.

The interfaces 125 are fitted at different positions on the motor vehicle 105 and may each comprise an antenna. Positions depicted in FIG. 1 for the interfaces 125 should be understood to be exemplary. Preferably, the interfaces 125 can be used both for transmitting and for receiving UWB signals in a frequency range from approximately 6 to 10 GHz. The further wireless interface 130 may comprise one or more further dedicated antennas. The wireless interface 130 preferably operates by means of BLE technology at a frequency of approximately 2.4 GHz.

The hand-held unit 110 comprises a processing device 140, at least one wireless interface 145, which preferably operates according to UWB technology, and preferably a further wireless interface 150, which preferably operates according to BLE technology. The wireless interface 145 is preferably designed both to transmit and to receive UWB signals. The interface 150 is designed to communicate with the interface 130 of the control apparatus 115 aboard the motor vehicle 105.

The hand-held unit 110 preferably comprises an energy source 155, which is more preferably an energy store 155 and in particular an electrochemical energy store 155. By way of example, the energy source 155 may comprise a storage battery or a battery. Optionally, there is provision for a buffer store 160 in order to level off a time characteristic of an energy draw from the energy source 155. The buffer store 160 preferably comprises a capacitor and may be decoupled from the energy source 155, for example by means of a diode.

A voltage monitor 165 can determine whether a voltage provided by the energy source 155, or a voltage provided to a component of the hand-held unit 110, falls below a predetermined threshold value. In this case, a signal can be provided to the processing device 140, said signal in one embodiment comprising a reset signal in order to return the processing device 140 to a predetermined state, and so the voltage monitor 165 can also be referred to as a reset generator 165. Providing a reset signal allows a processing of the processing device 140 to be interrupted or terminated. The voltage monitor 165 may also comprise an analog-to-digital converter that can be used by the processing device 140 to actively determine a voltage of the energy source 155 or of the buffer store 160. A determined voltage can be numerically compared with a predetermined threshold value.

What is not depicted in FIG. 1 is a user interface that a person can use to activate the hand-held unit 110, for example a pushbutton switch or a keypad. Activation allows a predetermined communication between the hand-held unit 110 and the motor vehicle 105 to be initiated. The communication can comprise a reciprocal authentication, which may be based on asymmetric cryptographic keys. Additionally, a range and/or a direction of the hand-held unit 110 in relation to the motor vehicle 105 can be determined.

The communication and the determination of the range or direction can be effected by means of different wireless technologies. The technologies can be used in combination or in an intertwined manner in order to permit an orderly procedure for the exchange of signals. By way of example, communication between the motor vehicle 105 and the hand-held unit 110, according to the Digital Car Key specifications, can proceed substantially as follows:
using BLE, the interfaces 130 and 150 are used to transmit information in order to configure a communication by means of the UWB interfaces 125, 145
the motor vehicle 105 puts all UWB interfaces 125 on standby
the hand-held unit 110 sends a pre-poll
the hand-held unit 110 sends a poll
a first UWB interface 125 sends a response. The hand-held unit 110 is on standby
the other UWB transmitting devices 125 each send a response in succession. The hand-held unit 110 is on standby
the hand-held unit 110 sends a Final packet
the hand-held unit 110 sends a Final_Data packet.

The individual UWB packets are transmitted in a short sequence. The typical configuration is one packet every T_Slot=2.667 ms (N_Chap_per_Slot=8). The slot time has previously been stipulated or negotiated between the hand-held unit 110 and the motor vehicle. The motor vehicle 105 can use the signal propagation times to determine the distances between the hand-held unit 110 and the vehicle anchors, and can use said distances to determine the position.

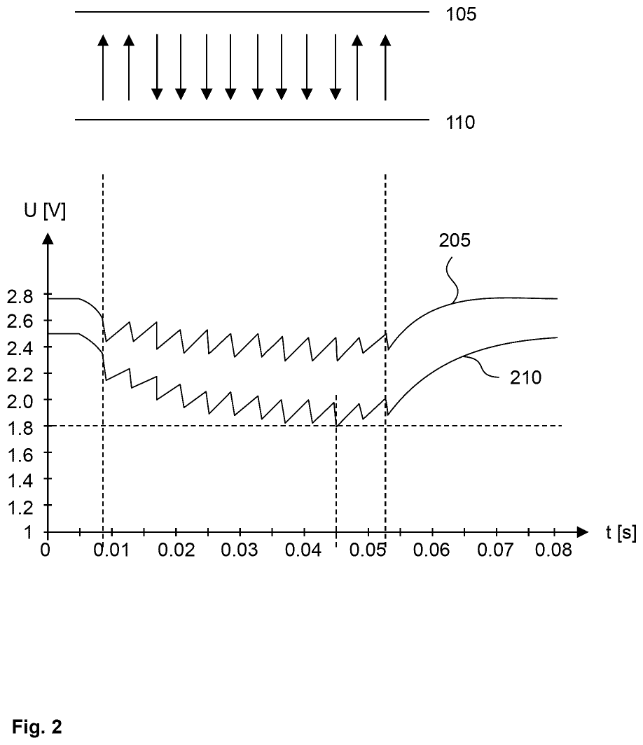

A lower region of FIG. 2 shows exemplary voltage characteristics for the receiving device 145 and the processing device 140 of a hand-held unit 110. A time in seconds is indicated in a horizontal direction and a voltage in volts is indicated in a vertical direction. A first characteristic 205 can arise if a capability of the energy source 155 is high; a second characteristic 210 is associated with an energy source 155 having medium or low capability. It should be noted that the characteristics 205, 210 are depicted schematically and qualitatively.

An upper region indicates messages that are exchanged between the hand-held unit 110 and a motor vehicle 105. A message is represented by an arrow that runs from the hand-held unit 110 to the motor vehicle 105, or vice versa, in the direction of transmission. Horizontal positions of the arrows correspond to times of the messages in the representation of the voltage characteristics.

Referring to the first characteristic 205, an open-circuit voltage of the energy source 155 is approximately 2.8 V. Should the voltage on the processing device 140 and/or receiving device 145 drop below a predetermined threshold value of, here, for example, 1.8 V, an undervoltage can be detected that results in the processing device 140 being reset to a predetermined state.

To determine a range or position of the hand-held unit 110 with respect to the motor vehicle 105, a series of impulses are normally exchanged between the motor vehicle 105 and the hand-held unit 110. The impulses each have predetermined time durations, and each impulse is spaced apart in time from a preceding or succeeding impulse by a predetermined time interval. The impulses are transmitted in succession by different transmitting devices 125 of the motor vehicle 105.

A propagation speed of a transmitted wireless impulse substantially corresponds to the speed of light. Owing to the different positions that the transmitting devices 125 on the motor vehicle 105 are in, distances that the individual impulses need to overcome to reach the receiving device 145 of the hand-held unit 110 are different in length. Accordingly, reception times of temporally successive impulses at the hand-held unit 110 are normally at different intervals of time than the predetermined time interval that exists between the impulses on transmission. A variance in a relative time difference between reception times and the time interval can be used to determine relative distances between the receiving device 145 and the different transmitting devices 125.

Operation of the receiving device 145 normally requires a significant energy draw from the energy store 155. To put it another way, an increased electric current can be drawn from the energy store 155 during reception. Owing to the finite electrical internal resistance of the energy source 155, the voltage of the energy source 155 falls if the receiving device 145 is switched on. This effect is moderated if there is provision for a capacitor 160. Times at which the receiving device 145 is switched on are represented by almost vertically falling sections of the characteristics 205, 210 in FIG. 2.

Since it is approximately known when reception of a transmitted impulse can be expected, the receiving device 145 is preferably operated only in such time ranges. Between these times, the receiving device 145 is switched off, meaning that the voltage of the energy source 155 can rise again. Rising normally takes place more slowly than falling.

The multiple loads on the energy source 155 owing to the series of impulses leads to the voltage provided on average falling overall. This is not critical for the first characteristic 205, as the voltage is not close to the threshold value of 1.8 V at any time.

Referring to the second characteristic 210, however, it may be that the voltage of the energy source 155 falls below the predetermined threshold value at least briefly. In the example depicted, this is the case at the time 0.045. The brief drop below the threshold value of 1.8 V may suffice to trigger the reset generator 165. Range or position determination may be ended early as a result.

It is proposed that the time interval that exists between the transmission of two successive impulses be increased if the capability of the electrical energy store 155 is not sufficient to reliably prevent the described drop below the threshold value. Time ranges for which the receiving device 145 is switched on can then be spread out over time by an appropriate amount. The energy store 155 can have an improved opportunity to regenerate, and raise the voltage provided by it, between loads produced by the receiving device 145.

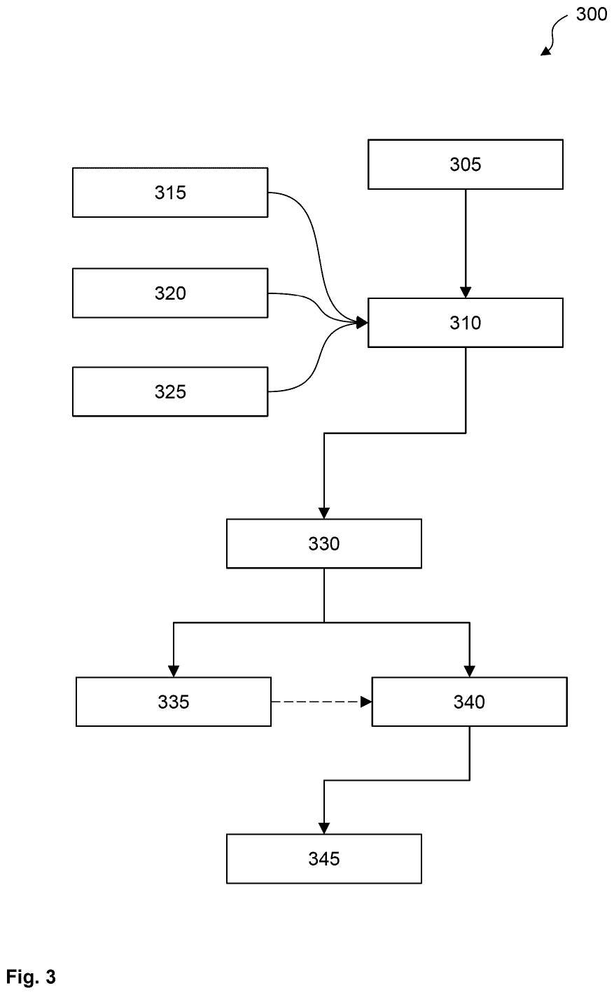

FIG. 3 shows a flowchart for an exemplary method 300. The method 300 can be performed in particular by means of a system 100.

A step 305 can comprise preparing for location of the hand-held unit 110 in relation to the motor vehicle 105. To this end, information can accordingly be exchanged between the hand-held unit 110 and the motor vehicle 105. Preferably, the data interchange is effected by means of the further interfaces 130, 150. In one embodiment, it is possible to prepare for location while the hand-held unit 110 is in communication range of the interfaces 130, 150, but not yet in communication range of the interfaces 125, 145. The actual location can take place only when the hand-held unit 110 is close enough to the motor vehicle 105 for wireless impulses to be able to be exchanged between the transmitting devices 125 and 145.

In a step 310, the hand-held unit 110 can determine a capability of the energy source 155. The capability can indicate the value to which a voltage provided by the energy source 155 dips if the receiving device 145 is switched on for a predetermined length of time. The greater this voltage, the greater may be the capability. The capability can be determined by taking account of what voltage the energy source 155 provides immediately before the receiving device 145 is switched on.

The capability can be determined on the basis of different concepts. In one embodiment, a step 315 can comprise determining a parameter of the energy source 155. The parameter may include in particular an open-circuit voltage, an electrical internal resistance or a temperature. One or more collected parameters of the energy source 155 can then be taken as a basis for determining the capability.

A step 320 can comprise determining whether a past position determination for the hand-held unit 110 in relation to the motor vehicle 105 resulted in the energy source 155 being overloaded. An overload can be detected if the voltage provided by the energy source 155 dropped below a predetermined threshold value. In this case, a time interval that was used for the past positioning can be extended. The extension can be produced with a predetermined increment. Should it be determined at a later time that the energy source 155 has been recharged or replaced, the time interval can be reset to a predetermined, low value.

A step 325 can comprise determining the capability of the energy source 155 on the basis of a model. The model can assume a predetermined energy that is stored in the energy source 155 or is retrievable from the energy source 155. Draws of energy from the energy source 155 can be tracked and a remaining or drawable energy can be determined on the basis of the model. The greater the remaining energy, the greater may be the capability of the energy source 155. It should be noted that the capability of the energy source 155 can be provided on the basis of one or more of steps 315 to 325 or portions thereof.

A step 330 can comprise negotiating a time interval between the hand-held unit 110 and the motor vehicle 105. This involves the hand-held unit 110 suggesting one or more intervals of different length, the shortest of which is preferably already long enough to prevent the energy source 155 from being overloaded during a position determination. If step 320 has previously been performed, the shortest offered time interval may correspond to the time interval determined in step 320. The motor vehicle 105 can confirm one of the offered time intervals, meaning that both sides 105, 110 know which time interval is used for positioning.

In a step 335, the hand-held unit 110 and the motor vehicle 105 can alternately transmit wireless impulses. The impulses are transmitted in succession, a time interval existing between successive impulses in each case. The impulses are preferably transmitted by different instances of the transmitting devices 125 and 145.

In a step 340, the hand-held unit 110 and the motor vehicle 105 can receive wireless impulses. To this end, the receiving devices 125 and 145 can be briefly activated whenever the arrival of a wireless impulse is expected.

A step 345 can comprise determining a direction and/or range of the hand-held unit 110 with respect to the motor vehicle 105. To this end, relative intervals of time between reception times of the transmitted wireless impulses can be taken into account. Given knowledge of the geometry in which the transmitting devices 125 are fitted at positions on the motor vehicle 105, a range and/or a direction of the hand-held unit 110 in relation to the motor vehicle 105 can be determined.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system
105 motor vehicle
110 hand-held unit
115 control apparatus
120 processing device
125 transmitting device
130 interface
140 processing device
145 receiving device
150 interface
155 energy source, energy store
160 buffer store
165 voltage monitor, reset generator
205 first characteristic
210 second characteristic
300 method
305 prepare for location
310 determine capability of the energy source
315 determine parameters of the energy source
320 on reset: extend time interval
325 model of the energy source
330 negotiate time interval
335 transmit impulses in time intervals
340 receive impulses
345 locate hand-held unit

What is claimed is:

1. A method for locating a hand-held unit with respect to a motor vehicle, the method comprising:
negotiating a time interval between the hand-held unit and the motor vehicle, wherein the time interval is negotiated on the strength of a capability of an energy source of the hand-held unit;
exchanging a series of wireless impulses between the motor vehicle and the hand-held unit, wherein the wireless impulses are transmitted from the hand-held unit and from different positions on the motor vehicle in a manner offset by the time interval; and
determining a location of the hand-held unit in relation to the motor vehicle on the basis of intervals of time between reception times of the wireless impulses at the hand-held unit.

2. The method of claim 1, wherein the time interval is extended as the capability of the energy source falls.

3. The method of claim 2, wherein the energy source provides a voltage and the capability is determined on the strength of the provided voltage.

4. The method of claim 1, wherein the energy source provides a voltage and the capability is determined on the strength of an electrical internal resistance of the energy source.

5. The method of claim 1, wherein the energy source comprises an electrochemical energy store, and the capability is determined on the strength of a temperature in the region of the energy store.

6. The method of claim 1, wherein the energy source comprises an energy store, and the capability of the energy store is determined on the basis of past energy draws from the energy store.

7. A hand-held unit for communication with a motor vehicle, comprising:
a wireless receiver;
an energy source; and
a processing device configured to:
negotiate a time interval with a motor vehicle on the strength of a capability of the energy source of the hand-held unit,
receive a series of wireless impulses transmitted from different positions on the motor vehicle in a manner offset by the time interval, and
determine a location of the hand-held unit in relation to the motor vehicle on the basis of intervals of time between reception times of the wireless impulses at the hand-held unit.

8. The hand-held unit of claim 7,
wherein the receiver is activated only if the arrival of a wireless impulse is expected, and
wherein a voltage of the energy source is reduced while the receiver is activated.

9. The hand-held unit of claim 7, wherein the energy source comprises a buffer store in order to briefly provide an increased electric current.

10. The hand-held unit of claim 7, wherein the time interval is extended if a voltage of the energy source drops below a predetermined threshold value during activation of the wireless receiver.

11. The hand-held unit of claim 10, further comprising:
a reset generator configured to put the processing device into a predetermined state if the voltage drops below the predetermined threshold value.

12. The hand-held unit of claim 7, further comprising:
a further wireless interface for communication with the motor vehicle.

13. The hand-held unit of claim 7, wherein the hand-held unit is configured to carry out a bilateral authentication with the motor vehicle, and to request a predetermined function of the motor vehicle.
